(19) United States
(12) Patent Application Publication
(10) Pub. No.: US 2007/0050425 A1
(43) Pub. Date: Mar. 1, 2007

(54) Log management program of a computer, log management method thereof, and computer system

(76) Inventors: Masaya Ichikawa, Sagamihara (JP); Hirofumi Nagasuka, Sagamihara (JP); Hideaki Sampei, Tokyto (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/299,827

(22) Filed: Dec. 13, 2005

(30) Foreign Application Priority Data
Aug. 23, 2005 (JP) 2005-241144

(51) Int. Cl. G06F 17/30

(52) U.S. Cl. 707/201

(57) ABSTRACT

According to the present invention, even when any one of the computers constituting a computer system becomes inoperable, a series of flow of distributed processing can be traced. Application program 120 in computer 100A requests computer 100B to perform a part of the series of the processes (S106). Log information items in the computer 100A, to which an ID issued to a series of processes is attached, are transmitted to the computer 100B by the log transmission program 152 in the computer 100A (S110). The log information receiving program 153 of the computer 100B receives these log information items and stores them in logbuffer 160 (S221, S222). The application program 120 in the computer 100B executes thus requested processing, and returns the process result to the computer 100A (S206). The log information items of the computer 100B each having the above ID, generated by executing the processing, are transmitted to the computer 100A by the log transmission program 152 of the computer 100B (S210) , and the log information receiving program 153 of the computer 100A receives this log information items and stores them in the log buffer 160 (S121, S222).

### CROSS-REFERENCE TO THE RELATED APPLICATION

This application relates to and claims priority from Japanese Patent Application No. 2005-241144, filed on Aug. 23, 2005, the entire disclosure of which is incorporated herein by reference.

### BACKGROUND OF THE INVENTION

The present invention relates to a computer system which performs distributed processing in multiple computers for a series of processing, a log management program of the computer which manages log information items generated in the course of executing the processing in the multiple computers, and a log management method of the computer.

Many computer systems retain a processing history in a form of log. In the event of failure, this log is referred to, and it is utilized as a means for analyzing a cause for the failure. In recent years, a configuration of the computer system becomes complicated, and there is also a case that multiple computers handle one task, that is, a distributed processing is performed for one task. In the computer system performing such distributed processing as described above, it is necessary to trace a processing flow by referring to each log with respect to each of the multiple computers in the event of failure. Therefore, maintenance works are extremely complicated and troublesome.

There is a prior art which is disclosed by the Japanese Patent Laid-open Publication No. 2004-227360, which simplifies the process of the log reference in the computer system which performs distributed processing, and supports maintenance works. This technique collects logs respectively from the multiple computers into one maintenance-use computer, reforms and displays thus collected logs. With this technique, a maintenance engineer is allowed to refer to the centralized logs, even if the tasks extend over multiple computers. Therefore, maintainability is enhanced, and an effect can be expected such that time required for the failure recovery is reduced.

### SUMMARY OF THE INVENTION

However, even though most of the log reference process is performed in the event of system failure, in the above prior art disclosed in the publication No. 2004-22736, there is a problem that if any one of the multiple computers constituting the computer system is inoperable due to the failure, the log in that inoperable computer is not allowed to be referred to, and tracing of the processing flow is interrupted halfway.

Considering such problem of the prior art, the object of the present invention is to provide a log management program, a log management method, and a computer system, which are capable of tracing a series of distributed processing flow, even when any one of the computers constituting the computer system becomes inoperable.

In order to solve the above problem, the present invention is directed to a log management program provided in a computer, when a series of processes are subjected to a distributed processing in a plurality of computers, the log management program managing log information items with respect to each of the processes, the log information items being generated in course of executing the series of the processes, the log management program including,

own processing log storing step in which a log information item generated in course of processing in the computer is stored in a memory within the computer,

log receiving step in which after the computer has transmitted data to another computer and allowed the other computer to process the data, the computer receives from the other computer a log information item generated by the other computer in a process relating to the data, and when another computer transmits data to the computer and allows the computer to process the data, the computer receives a log information item from the other computer generated by the other computer in a process relating to the data, and

other processing log storing step which stores within the memory the log information item received by the log receiving step.

Here, it is preferable the log management program further allows the computer to execute,

a log transmitting step in which when the computer transmits data to another computer and allows the other computer to process the data, the computer transmits to the other computer, a log information item generated by the computer in a process relating to the data, and after the other computer has transmitted data to the computer and allowed the computer to process the data, the computer transmits to the other computer a log information item generated by the computer in a process relating to the data.

In order to solve the above problem, the present invention is directed to a log management method provided in a computer, when a series of processes are subjected to a distributed processing in a plurality of computers, the log management method managing log informationitemswithrespect to each of the processes, the log information items being generated in course of executing the series of the processes, the log management method including,

own processing log storing step in which a log information item generated in course of processing in the computer is stored in a memory within the computer,

log receiving step in which when the computer transmits data to another computer and allows the other computer to process the data, the computer receives from the other computer a log information item generated by the other computer in a process relating to the data, and when another computer transmits data to the computer and allows the computer to process the data, the computer receives a log information item from the other computer generated by the other computer in a process relating to the data, and

other processing log storing step which stores within the memory the log information item received by the log receiving step.

In order to solve the above problem, the present invention is directed to a computer system provided with a plurality of computers, and when a series of processes are subjected to a distributed processing in the plurality of computers, the computer system managing log information items with respect to each of the processes, the log information items being generated in course of executing the series of the processes, wherein,

a first computer in the plurality of computers is provided with a processor and a memory, and the processor in the first computer executes,

own processing log storing step in which a log information item generated in course of processing in the first computer is stored in a memory within the first computer,

processing data transmission step which transmits unprocessed data to a second computer in the plurality of computers,

processing data receiving step which receives unprocessed data from the second computer,

log receiving step which receives from the second computer a log information item generated in a process by the second computer, relating to the unprocessed data that has been transmitted to the second computer by the processing data transmission step, and receives from the second computer the log information item generated in a process by the second computer, relating to the unprocessed data in course of transmitting the unprocessed data from the second computer, and

other processing log storing step which stores within the memory the log information item received by the log receiving step, wherein,

the second computer is provided with a processor, and the processor in the second computer executes,

processing data receiving step which receives the unprocessed data transmitted from the first computer,

processing data transmission step which transmits the unprocessed data to the first computer, and

log transmission step which transmits to the first computer the log information item generated in a process relating to the unprocessed data from the first computer received by the processing data receiving step in the second computer, and transmits to the first computer the log information item generated in the process relating to the unprocessed data in course of transmitting the unprocessed data in the processing data transmission step in the second computer.

According to the present invention, one computer and another computer in a plurality of computers which perform distributed processing as to a series of processes, store redundantly with each other a log information item generated in a process in one computer. Therefore, even when any one of the computers becomes inoperable, it is possible to trace a flow of the series of distributed processing.

### BRIEF DESCRIPTION OF THE DRAWING

FIG. 1 is a block diagram of a computer system according to one embodiment of the present invention.

FIG. 2 is an illustration showing a configuration of a processing data transfer program according to one embodiment of the present invention.

FIG. 3 is an illustration showing a configuration of a log management program according to one embodiment of the present invention.

FIG. 4 is an illustration showing a configuration of log information according to one embodiment of the present invention.

FIG. 5 is an illustration showing a configuration of a log management table according to one embodiment of the present invention.

FIG. 6 is an illustration showing a configuration of communication target management table entry according to one embodiment of the present invention.

FIG. 7 is a flowchart showing processing descriptions in the processing data transmission program according to one embodiment of the present invention.

FIG. 8 is a flowchart showing processing descriptions in the processing data receiving program according to one embodiment of the present invention.

FIG. 9 is a flowchart showing processing descriptions in a log recording program according to one embodiment of the present invention.

FIG. 10 is a flowchart of processing descriptions in a log transmission program according to one embodiment of the present invention.

FIG. 11 is a flowchart of processing descriptions in a log receiving program according to one embodiment of the present invention.

FIG. 12 is an illustration showing flows of major data and log information according to one embodiment of the present invention.

### DETAILED DESCRIPTION OF PREFERRED EMBODIMENTS

A computer system according to one embodiment of the present invention will be explained with reference to the accompanying drawings.

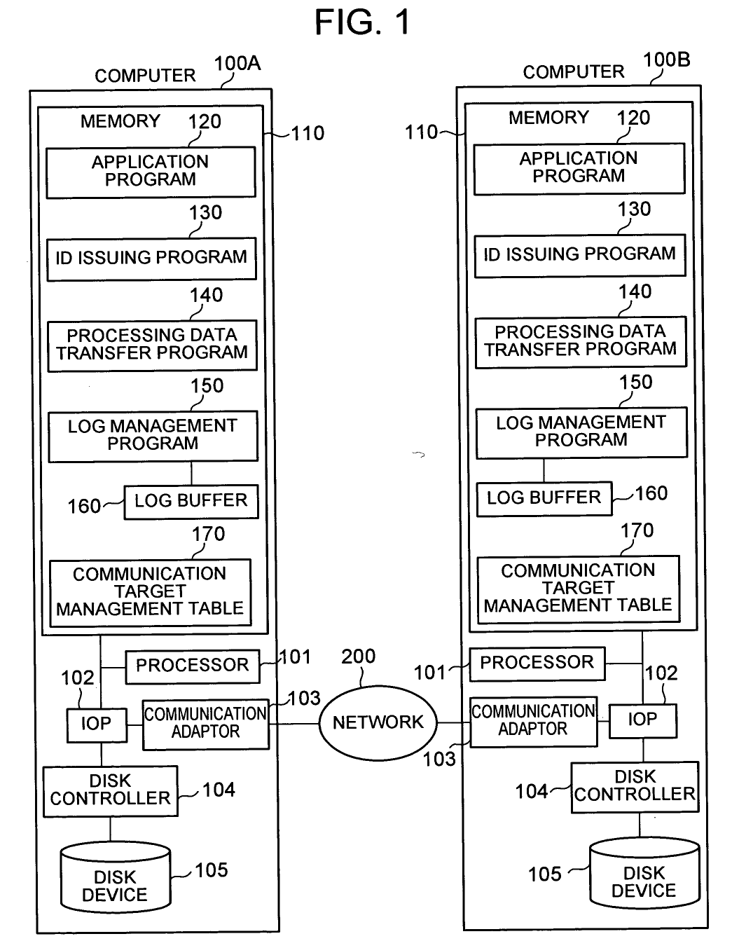

As shown in FIG. 1, in the computer system according to the present embodiment, a plurality of computers 100A and 100B are connected with each other via network 200. In FIG. 1, for ease of following explanation, there are shown only two computers 100A and 100B being connected, however, more than two computers may be connected, and other equipment may be connected.

Each of the computers 100A and 100B is provided with main processor 101, I/O processor (hereinafter, referred to as IOP: Input Output Processor) 102, communication adaptor 103, disk controller 104, disk device 105, and memory 110.

The memory 110 stores application program 120, ID issuing program 130, processing data transfer program 140, and log management program 150, and the like, which are executed by the main processor 101. In this memory 110, there are reserved a region for log buffer 160 where log management table is expanded and a region for communication target management table 170.

A single application program 120 or multiple application programs 120 exist, to carry out operations such as transaction processing. In practice, the main processor 101 which executes this application program 120 carries out operations such as transaction processing, but here, for ease of explanation, the program is assumed to be the subject that carries out the operations. Further in the following discussion, it is assumed similarly as described above, when the operations of the main processor 101 are explained, which are implemented by executing a program.

The ID issuing program 130 is a program which allocates processing IDs identifiable in the entire computer system, respectively to a series of processing, i.e., transactions, which are executed by a processing request that the application program 120 has received from outside. Here, it is a matter of course that if all the application programs 120 allocate processing IDs by themselves, this ID issuing program 130 is not necessary.

The processing data transfer program 140 is a program which transmits and receives unprocessed data when the application program 120 requests an application program in another computer to perform processing, and further which transmits and receives result data processed in the application program in the other computer. This processing data transfer program 140 uses the IOP 102, in transmitting/receiving data, to control the communication adapter 103, and transmits and receives the data via the network 20. It is to be noted that a device driver for use in communication may be additionally provided and involved in the above configuration.

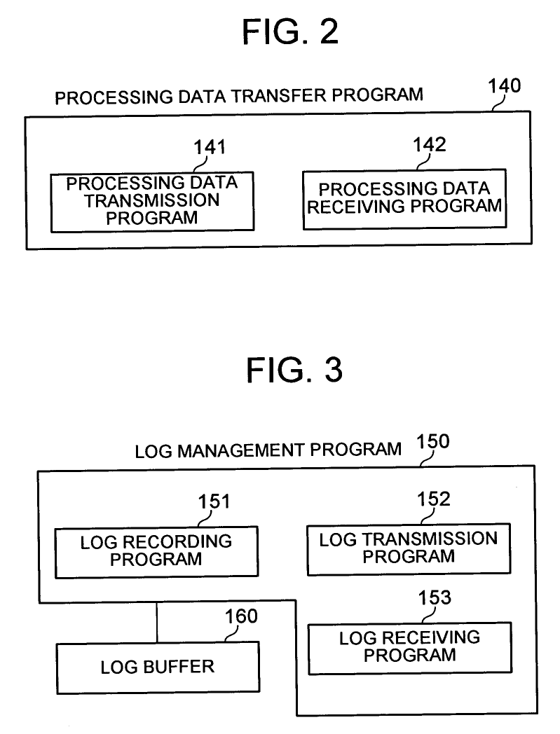

More particularly, as shown in FIG. 2, the processing data transfer program 140 includes processing data transmission program 141 and processing data receiving program 142. The processing data transmission program 141 is called by the application program 120, and the program 141 transmits unprocessed data to be processed by the application program 120 in another computer, or a result data processed in the application program 120 in its own computer, to the processing data receiving program 142 in the other computer. The processing data receiving program 142 receives the unprocessed data or the process result data, transmitted from the processing data transmission program 141 in the other computer, and passes thus received data to the application program 120.

The log management program 150 is a program which records in the log buffer 160 the log information which is requested from the application program 120 to be recorded, and simultaneously transmits this log information to the other computer. Further, the program 150 receives log information from the other computer. This log management program 150 decides a transmitting destination, when the log information is to be transmitted, based on the contents of the communication target management table 170, and upon receipt of the log information from the other computer, the log management program 150 merges this received information with the log information of the application program 120 in its own computer, and records the merged information in the log buffer 160.

More particularly, as shown in FIG. 3, this log management program 150 includes log recording program 151, log transmission program 152, and log receiving program 153. The log recording program 151 accepts a request for recording the log information from the application program 120, and stores the log information in the log buffer 160. The log transmission program 152 accepts a transmission request from the processing data transfer program 140, and transmits the log information stored in the log buffer 160 to another computer. The log receiving program 153 receives the log information transmitted from the other computer, merges the transmitted log information with the log information in its own computer, and stores the merged information in the log buffer 160.

The log buffer 160 is a region in the memory 110 which stores log information generated in its own computer, and log information generated in the other computer and transmitted therefrom. When the log information is received from the other computer and this received log information is stored in the log buffer 160, the recorded contents in the log buffer 160 is stored in the disk device 105, which will be explained below.

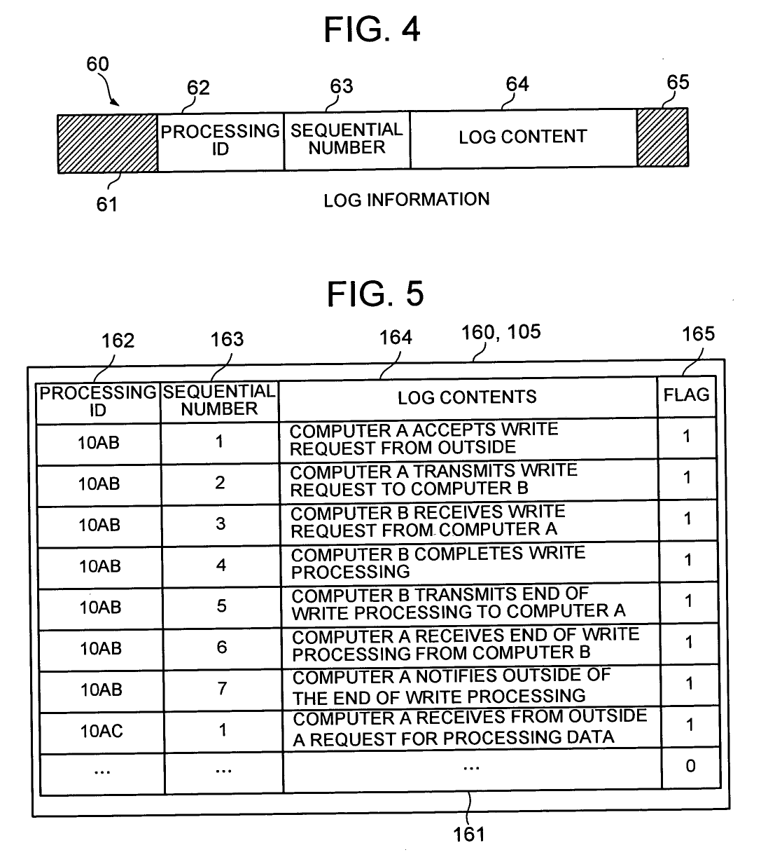

As shown in FIG. 4, log information 61 includes an ID issued by the ID issuing program 130, i.e., a processing ID data 62 which is identifiable in the entire computer system with respect to one transaction, log content 64 which represents processing descriptions of each process in a series of processes, and sequential number data 63 which indicates a sequence of processing in the series of processes. This log information 61 is transmitted and received in the form of packets. This packet may also store other information in the areas 61, 65, besides the areas for the processed ID data 62, sequential numbers data 63, and log content 64.

As shown in FIG. 5, log management table 161 is expanded in the log buffer 160 and the disk device 105, in which the log information 61 as described above is stored. The log management table 161 is provided with processing ID column 162, sequential number data column 163, and log content column 164, which respectively store the processing ID 62, sequential number 63, and log content 64, constituting the log information 61. In addition, this log management table 161 is further provided with an already-transmitted flag column 165, which indicates whether or not the log information has already been transmitted. This already-transmitted flag column 165 stores “0” for the not-yet-transmitted log information and it stores “1” for the already-transmitted log information.

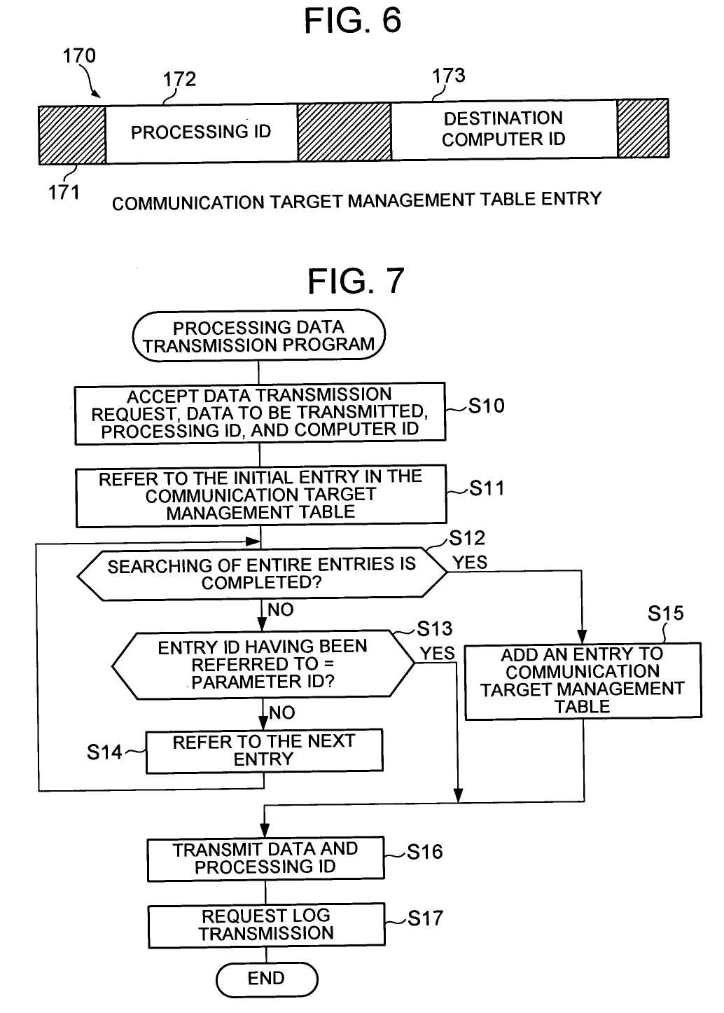

The communication target management table 170 is a table which manages an association between the processing ID issued by the ID issuing program 130, and a computer as a destination for transmitting the unprocessed data or the process result data. Contents of the communication target management table 170 are updated by the processing data transfer program 140 and the log management program 150. As shown in FIG. 6, table entry of this communication target management table 170 includes, processing ID 172 issued by the ID issuing program 130, and a computer ID 173 being a transmitting destination of the unprocessed data or process result data. It is to be noted that free space 171 of this entry maybe used to store other information.

Next, operations of each program, to be exact, operations of the processor 101 when the processor executes each program, will be explained.

At first, according to the flowchart as shown in FIG. 7, the processing procedure in the processing data transmission program 141 in the processing data transfer program 140 will be explained.

The processing data transmission program 141 accepts, together with a request for transmitting unprocessed data or process result data from the application program 120, the data itself, the processing ID of this data, and a computer ID as a destination (S10). Subsequently, this processing data transmission program 141 refers to the initial entry in the communication target management table 170 (S11). At this time, if there is no entry to be referred to, or the table is empty (S12), the processing proceeds to step 15, assuming that all the entries have already been searched. On the other hand, if there is an entry to be referred to, it is determined whether or not the processing ID of this entry and the processing ID accepted in step 10 are identical, and whether or not the computer ID of this entry and the computer ID accepted in step 10 are identical. If both of them are identical, the processing proceeds to step 16. If either of them is not identical or neither is identical, the processing proceeds to step 14 and refer to the next entry, and then returns to step 12.

If it is determined in step 12 that all the entries have been searched, and the processing proceeds to step 15, an entry is added in the communication target management table 170, and the processing ID and the computer ID accepted in step 10 are stored in this added entry. Then, the processing proceeds to step 16. The communication target table 170 thus updated as described above is utilized as destination data when the log information is transmitted as discussed below.

In step 16, the data accepted in step 10 is transmitted to the computer indicated by the computer ID. At this time, the data to be transmitted includes the processing ID of this data, and computer ID of its own computer as a transmission source.

Finally, using the processing ID accepted in step 10 as a parameter, the log transmission program 152 is called, to complete a transmission process of the processing data. It is to be noted that calling of this log transmission program 152 is performed so as to transmit to the computer as a data destination, the log information of its own computer, in sync with the aforementioned data transmission, as described below.

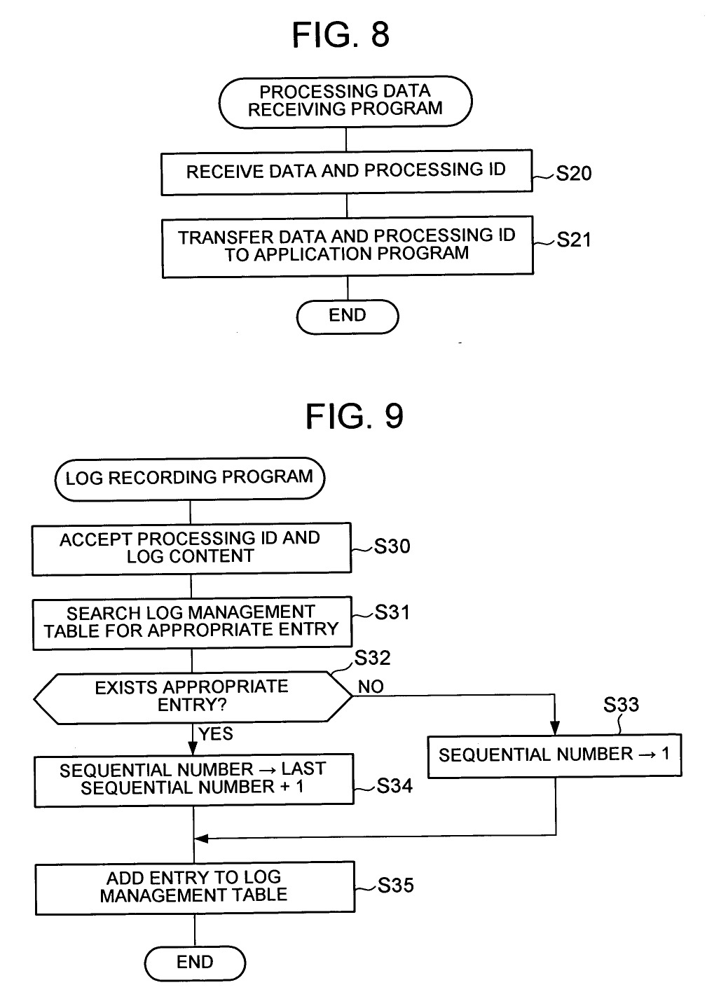

Next, according to the flowchart as shown in FIG. 8, a processing procedure of the processing data receiving program 142 in the processing data transfer program 140 will be explained.

When the processing data receiving program 142 receives from the other computer, unprocessed data or process result data, and processing ID thereof (S20), the program 142 passes this data and processing ID to the application program 120, and then, completes the processing (S21). In addition, when the processing data receiving program 142 passes the data and processing ID to the application program 120, it is also possible for the program 142 to pass to the application program 120, its own computer ID and a computer ID as a transfer source of the data.

Next, according to the flowchart as shown in FIG. 9, a processing procedure of the log recording program 151 in the log management program 150 will be explained.

Triggered by a generation of log content by the application program 120, the log recording program 151 receives from the application program 120, the processing ID issued by the ID issuing program 130 and the log content (S30) . When the log recording program 151 receives the processing ID and the log content, the program 151 searches the log management table 161 as shown in FIG. 5 for an entry of the processing ID which is identical to the processing ID received in step 30 (S31). If there is not an identical processing ID in the log management table 161 (S32) , the sequential number is set to 1 (one) assuming that the processing ID received in step S30 is a new processing ID (S33). On the other hand, if there is an identical processing ID in the log management table 161 (S32) , the program 151 retrieves an entry having the last sequential number out of the entries having this processing ID, and a value obtained by adding 1 (one) to this last sequential number is set as a new sequential number (S34). Finally, the entry is added to the log management table 161, and the processing ID and the log content received in step 30 are stored in the added entry. Simultaneously, the sequential number generated in step 33 or step 34, is stored in the added entry (S35).

It is to be noted that as the added entry, a new memory region may be reserved, or an already-used entry may be diverted to the added entry. Here, the sequential number is included in the log information, but it is not necessarily included therein. For example, the clock time when the processing indicated by the log content was executed is received from the application program 120 together with the log content, and this clock time may be included in the log information instead of the sequential number.

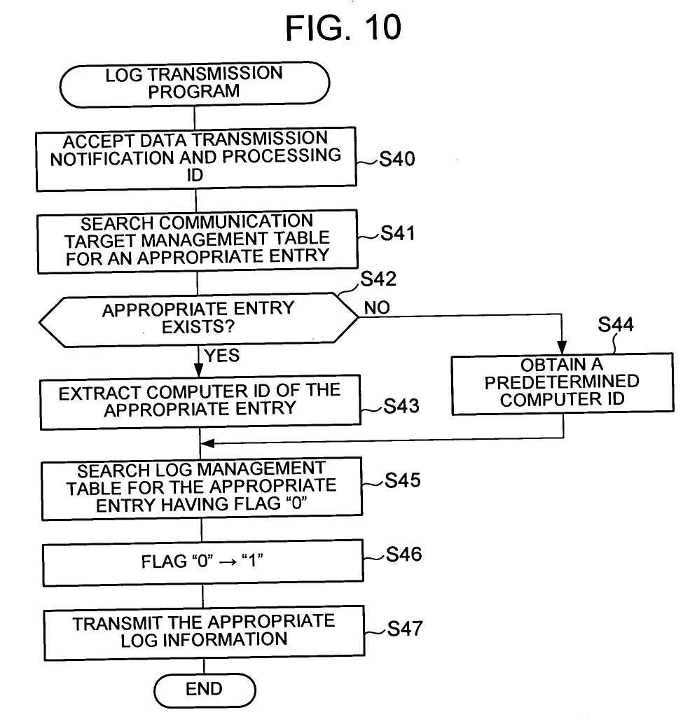

Next, according to the flowchart as shown in FIG. 10, a processing procedure of the log transmission program 152 in the log management program 150 will be explained.

When the log transmission program 152 accepts a data transmission notice and a processing ID of this data from the processing data transmission program 141 (S40), the program 152 searches the communication target management table 170 for an entry with the processing ID accepted in step 40 (S41). If there is a corresponding entry (S42) , a computer ID of this entry is extracted (S43). If the corresponding entry does not exist (S42) , a predetermined computer ID is obtained (S44).

Next, the log transmission program 152 searches the log management table 161 as shown in FIG. 5 for an entry with the processing ID accepted in step 20, and further retrieves an entry having the already-transmitted flag “0”, out of the entries having the above processing ID (S45). After the already-transmitted flag obtained in the above search is set to “1” (S46) , the log transmission program 152 transmits the data of the already-transmitted flag together with the log information of this entry, to the computer having the computer ID obtained in step 43 or step 44 (S47) . At this stage, if there are more than one entries obtained in the search of step 45, that is, there are more than one log information items, all the multiple log information items are transmitted.

In the processing above, the log transmission program 152 is allowed to start up when the data transmission notice from the processing data transmission program 141 is received, so that the log information is transmitted in sync with the unprocessed data or process result data. However, the transmission of the unprocessed data or process result data is not necessarily sync with the log information. For example, the log information may be transmitted every constant time interval which is managed by a timer. Alternatively, the stored data volume in the log buffer 160 is managed, and the log information may be transmitted, when this stored data volume reaches a predetermined data volume, for instance, a data volume which does not allow any new data entry. This log transmission program 152 may further include a transmission timing accepting step which accepts from outside at what timing the log information is to be transmitted, the timing selected from the following; at timing in sync with the data transmission, at timing when the time interval becomes a predetermined time interval, and at timing when the data stored volume in the log buffer 160 reaches a predetermined volume. Then, it may be configured such that the log information is transmitted at the timing accepted in the above transmission timing accepting step.

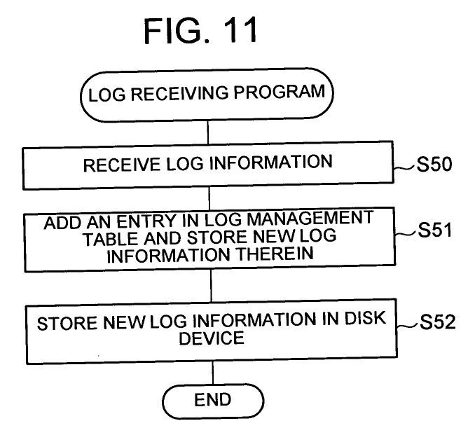

Next, according to the flowchart as shown in FIG. 11, a processing procedure of the log receiving program 153 in the log-management program 150 will be explained.

When the log receiving program 153 accepts log information from another computer (S50) , the program adds entries the number of which corresponds to that of thus accepted log information items, into the log management table in the log buffer 160, and stores the log information items in the added entries (S51) . Here, this log information includes not only the processing ID, sequential number, and log content which constitute the log information, but also data as to the already-transmitted flag. In addition, at the time of storing this log information, the log information items are stored after being merged in such a manner that the log information items are arranged sequentially according to the sequential numbers thereof.

When new log information is stored in the log buffer 160, this new log information is also stored in the log management table of the disk device 105 (S52). A format used for storing the information into the disk device may be the image as on the log buffer 160, but it may be stored after converted to another format.

In the present embodiment, when the received log information is stored in the log buffer 160 (S51) , the memory content in the log buffer 160 is also stored in the disk device 105 (S52). However, processing in step 52 after the step 51 may be omitted. For this case, it is preferable that the memory content in the log buffer 160 is stored in the disk device 105, periodically or every time when any more new entry cannot be added in the log buffer 160.

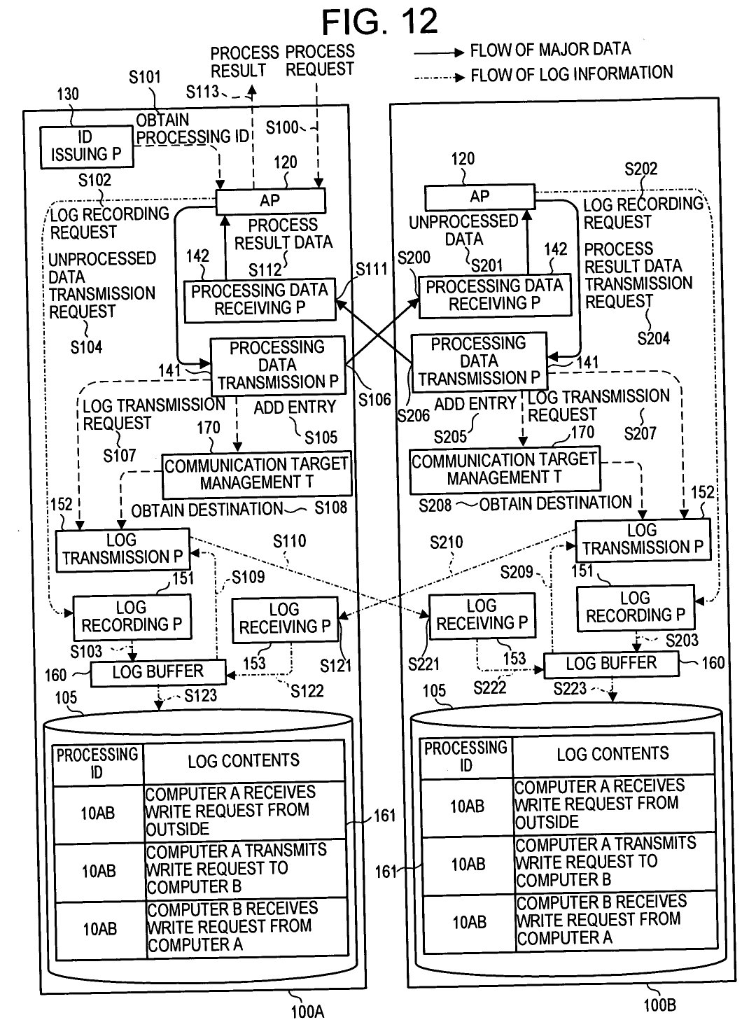

Next, with reference to FIG. 12, a flow of major data and log information will be explained. Here, processing in each program together with the flow of major data and log information will be explained, assuming that the computer 100A receives a processing request from outside, the computer 100B is requested to perform processing, the computer 100B carries out the processing, and then, a result of the processing is returned to the computer 100A. Further in FIG. 12, a flow of major data is indicated by solid lines, a flow of the log information is indicated by alternate long and short dashed lines, and a flow of other requests and data is indicated by dashed lines.

When the application program 120 in the computer 100A receives a processing request from outside (S100) the program 120 requests the ID issuing program 130 to issue a processing ID, and receives the processing ID from the ID issuing program 130 (S101). Unless otherwise noted, the processing within the computer 100A will be explained in the following.

Next, the application program 120 performs processing in accordance with the processing request from outside, and when a log recording event occurs, the program requests the log recording program 151 to record the log (S102). At this time, the application program 120 passes the processing ID obtained in step 101 and the log content to the log recording program 151.

As already explained with reference to FIG. 9, the log recording program 151 adds an entry to the log management table in the log buffer 160, attaches a sequential number to the log content received from the application program 120, and stores this sequential number, together with the processing ID and log content, into thus added entry of the log management table in the log buffer 160 (S103).

On the other hand, the application program 120 requests the processing data transmission program 141 to transmit unprocessed data to the computer 100B (S104) At this time, the application program 120 passes the unprocessed data to be transmitted, its processing ID, and a computer ID as a destination, to the processing data transmission program 141.

As explained above with reference to FIG. 7, when the processing data transmission program 141 receives the unprocessed data, processing ID, and computer ID, the program 141 adds an entry to the communication target management table 170. After the processing ID and the computer ID are stored in the added entry (S105), the program 141 transmits the unprocessed data and the processing ID to the computer 100B (S106) . Then, the processing data transmission program 141 requests the log transmission program 152 to transmit a log (S107) At this time, the processing data transmission program passes the processing ID to the log transmission program 152 together with the log transmission request.

The log transmission program 152 obtains a destination computer ID from the communication target table 170 based on the processing ID passed as a parameter (S108), obtains the log information from the log management table in the log buffer 160, and transmits this log information to the computer 100B indicated by the computer ID (S110).

For example, if the processing request from outside in step 100 is a write request to write a certain data item, the unprocessed data transmitted from the computer 100A to the computer 100B includes the write request, data to be written, and the like. At the stage where this unprocessed data is being transmitted to the computer 100B (S106) , the log management table 161 stores, for example as shown in FIG. 5,
1) the first log information in which the processing ID is “10AB”, the sequential number is “1”, the log content is “the computer A accepts a write request from outside”, and
2) the second log information in which the processing ID is the same “10AB”, the sequential number is “2”, the log content is “the computer A transmits the write request to the computer B”. It is to be noted that at this stage (S106), the already-transmitted flag column 165 of any of the above log information items are set to “0”, indicating “not-yet-transmitted”.

When the log transmission program 152 receives from the processing data transmission program 141, a transmission request to transmit the log information with the processing ID “10AB”. (S107), the program 152 extracts from the log management table 161 as described above, log information having the processing ID “10AB” and “0” (not-yet transmitted) set in the flag column 165, that is, the aforementioned first log information and the second log information (S109), and sets “1” (already transmitted) in each already-transmitted flag column 165 of the first log information and the second log information (S45 and S46 in FIG. 10). Then, the program 152 transmits those flag data items together with the log information items to the computer 100B (S110).

Unless otherwise noted, the processing within the computer 100B will be explained in the following.

The unprocessed data and its processing ID transmitted by the processing data transmission program 141 in the aforementioned step 106 are received by the processing data receiving program 142 in the computer 100B (S200), and passed to the application program 120 therein (S201).

In addition, the log information and the like transmitted by the log transmission program 152 in the computer 100A in the above step 110 are received by the log receiving program 153 (S221), stored in the log buffer 160 (S222), and thereafter stored in the disk device 105 (S223). It is to be noted that at this point of time, the recorded content in the log management table 161 within the disk device 105 is identical to the recorded content in the log management table within the log buffer 160 in the computer 100A, and the content indicates the first log information and the second log information in the computer 100A. In addition, each already-transmitted flag column 165 of the log information items is set to “1”, indicating that the log information items have already been transmitted.

The application program 120 of the computer 100B processes the unprocessed data passed in step 201, and when a log recording event occurs, the application program requests the log recording program 151 to record the log (S202) . At this time, the application program 120 passes the processing ID and the log content obtained in step 201 to the log recording program 151.

As explained above with reference to FIG. 9, the log recording program 151 in the computer 100B also adds an entry to the log management table in the log buffer 160, attaches a sequential number to the log content received from the application program 120, and stores as log information, the processing ID and log content together with the above sequential number, in thus added entry of the log management table in the log buffer 160 (S103).

On the other hand, when processing of the unprocessed data passed from the computer 100A is completed, then getting into the status that the process result data can be returned to the computer 100A, the application program 120 requests the processing data transmission program 141 to transmit the process result data to the computer 100A (S204) . At this time, the application program 120 passes the process result data to be transmitted, its processing ID, and the destination computer ID to the processing data transmission program 141.

As explained above with reference to FIG. 7, when the processing data transmission program 141 of the computer 100B receives the process result data, the processing ID, and the computer ID, the program 141 firstly adds an entry in the communication target management table 170, stores the processing ID and the computer ID in this added entry (S205) , and thereafter, transmits the process result data and the processing ID to the computer 100A (S206). Then, the processing data transmission program 141 requests the log transmission program 152 to transmit a log (S207). At this time, the processing data transmission program passes the processing ID together with the log transmission request to the log transmission program 152.

The log transmission program 152 obtains a destination computer ID from the communication target table 170 based on the processing ID passed as a parameter (S208) , obtains the log information from the log management table in the log buffer 160 (S209), and transmits this log information to the computer 100A indicated by the computer ID (S210).

For example, as explained above, when the process request from outside in step 100 is a write request to write a certain data item, the process result data transmitted from the computer 100B to the computer 100A is “end of write processing”. In the stage that the process result data is being transmitted to the computer 100A (S206), the log management table 161 in the log buffer 160 stores, for example as shown in FIG. 5,
1) the first log information having the sequential number “1”, and
2) the second log information having the sequential number “2”, and in addition,
3) the third log information having the processing ID “10AB”, the sequential number “3”, and the log content indicates “the computer B receives the write request from the computer A”,
4) the fourth log information having the same processing ID “10AB”, the sequential number “4”, the log content indicates “the computer B ends the write processing”, and
5) the fifth log information having the same processing ID “10AB”, the sequential number “5”, the log content indicates “the computer B transmits “end of write processing” to the computer A”.

In addition, in this stage (S206), the already-transmitted flag column 165 in each of the first and the second log information is set to “1” indicating the log information has already been transmitted, whereas the already-transmitted flag column 165 in each of the third information, the fourth information, and the fifth log information is set to “0” indicating the log information has not been transmitted yet.

When the log transmission program 152 receives from the processing data transmission program 141, the transmission request to transmit the log information with the processing ID “10AB” (S207), the program 152 extracts from the log management table 161 as described above, log information having the processing ID “10AB” and “0” (not yet transmitted) set in the flag column 165, that is, the aforementioned third log information, the fourth log information, and the fifth information (S209), and sets “1” (already transmitted) in each already-transmitted flag column 165 of the third log information, the fourth log information, and the fifth log information (S45 and S46 in FIG. 10). Then, the program 152 transmits those flag data items together with the log information items to the computer 100A (S210).

Unless otherwise noted, the processing within the computer 100A will be explained in the following.

The processing data receiving program 142 in the computer 100A receives the process result data and the processing ID (S111), which are transmitted in the aforementioned step 206 by the processing data transmission program 141 in the computer 100B, and passes the data and the processing ID to the application program 120 (S112). According to the process result data, this application program 120 continues the processing, or notifies the outside which requested the processing that the processing has been completed (S113). Furthermore, the log receiving program 153 in the computer 100A receives the log information and the like transmitted in the above step 210 by the log transmission program 152 in the computer 100B (S121). The log information and the like are stored in the log buffer 160 (S122), and then, they are stored in the disk device 105 (S123).

At this time in the process, the recorded content in the log management table 161 within the disk device 105 is identical to the recorded content at the same timing in the log management table within the log buffer 160 in the computer 100B.

As described above, in the present embodiment, when the distributed processing is performed assuming a processing request from outside as a unit of processing, log information is transmitted to another computer relating to the processing request in addition to the computer which has received the processing request, and this log information is redundantly recorded. Therefore, even when any one of the computers being subjected to the distributed processing becomes inoperable, a flow of a series of the distributed processing can be traced.

Here, it is to be noted that in the above embodiment, a computer system including two computers 100A and 100B is taken as an example. However, the present invention is not limited to this example, and it is a matter of course that the present invention can be applied to the computer system including three computers or more. For instance, here it is assumed a case that the computer A receives a processing request from outside, allows the computer B to execute a part of the processing, and then allowing the computer C to execute another part of the processing. When the present invention is applied to the above case, the computer A stores log information relating to the distributed processing in the computer B and the log information relating to the distributed processing in the computer C, in addition to the log information of its own computer A. The computer B stores the log information of the computer A in addition to the log information of its own computer B, and the computer C stores the log information of the computer A in addition to the log information of its own computer C.

In addition, the aforementioned embodiment handles the log information relating to the processing executed by the application program 120. However, the present invention is not limited to this. For example, log information associated with the processing executed by other components, such as ID issuing program 130, processing data transmission program 141, processing data receiving program 142, log recording program 151, log transmission program 152, log receiving program 153, and the like, may also be transmitted to another computer, received from the other computer, and stores such log information, according to the similar manner as described in the above embodiment.

What is claimed is:

1. A log management program provided in a computer, when a series of processes are subjected to a distributed processing in a plurality of computers, the log management program managing log information items with respect to each of the processes, the log information items being generated in course of executing the series of processes, said log management program comprising,
own processing log storing step in which a log information item generated in course of processing in said computer is stored in a memory within the computer,
log receiving step in which after said computer has transmitted data to another computer and allowed the other computer to process the data, the computer receives from the other computer a log information item generated by the other computer in a process relating to the data, and when another computer transmits data to the computer and allows the computer to process the data, the computer receives a log information item from the other computer generated by the other computer in a process relating to the data, and
other processing log storing step which stores within said memory said log information item received by said log receiving step.

2. The log management program according to claim 1, further allowing said computer to execute,
a log transmitting step in which when said computer transmits data to another computer and allows the other computer to process the data, said computer transmits to the other computer, a log information item generated by the computer in a process relating to the data, and after the other computer has transmitted data to the computer and allowed the computer to process the data, the computer transmits to the other computer a log information item generated by the computer in a process relating to the data.

3. The log management program according to claim 1, wherein,
said log information item includes a unique processing identifier attached to a series of processes which are executed by a processing request from out side, and with the processing identifier, the series of processes are distinguished from other series of processes, and
in said own processing log storing step and in said other processing log storing step, the log information item including said processing identifier is stored in said memory.

4. The log management program according to claim 2, wherein,
said log information item includes a unique processing identifier attached to a series of processes which are executed by a processing request from outside, and with the processing identifier, the series of processes are distinguished from other series of processes, and
in said own processing log storing step and in said other processing log storing step, the log information item including said processing identifier is stored in said memory.

5. The log management program according to claim 3, allowing said computer to execute a sequential number issuing step which includes sequential numbers respectively into the log information items each generated in course of executing a series of processes, wherein,
in said sequential number issuing step, when the sequential number is included in the log information item, a value obtained by adding one to the sequential number of the log information item including the last sequential number, out of the log information items having the processing identifier identical to the processing identifier of the log information item that is to include the sequential number, is set as a sequential number of the log information item, and if there is not a log information item of the processing having a processing identifier identical to the processing identifier of the log information, an initial number of the sequential number is set as the sequential number.

6. The log management program according to claim 4, allowing said computer to execute a sequential number issuing step which includes sequential numbers respectively into the log information items each generated in course of executing a series of processes, wherein,
in said sequential number issuing step, when the sequential number is included in the log information item, a value obtained by adding one to the sequential number of the log information item including the last sequential number, out of the log information items having the processing identifier identical to the processing identifier of the log information item that is to include the sequential number, is set as a sequential number of the log information item, and if there is not a log information item of the processing having a processing identifier identical to the processing identifier of the log information, an initial number of the sequential number is set as the sequential number.

7. The log management program according to claim 1, wherein,
in said log transmission step, said log information item is transmitted at timing selected from following points of time; at timing when a time interval becomes a predetermined interval, at timing being synchronized with transmission of said data, and at timing when stored data volume within said memory reaches a predetermined volume.

8. The log management program according to claim 7, wherein,
said log transmission step includes a transmission timing accepting step which accepts from outside at what timing the log information item is to be transmitted, which is selected from the following points of time; at timing when a time interval becomes a predetermined interval, at timing being synchronized with transmission of said data, and at timing when stored data volume within said memory reaches a predetermined volume, and at the timing accepted by the transmission timing accepting step, said log information item is transmitted.

9. A log management method provided in a computer, when a series of processes are subjected to a distributed processing in a plurality of computers, the log management method managing log information items with respect to each of the processes, the log information items being generated in course of executing the series of the processes, the log management method comprising,
own processing log storing step in which a log information item generated in course of processing in said computer is stored in a memory within the computer,
log receiving step in which after the computer has transmitted data to another computer and allowed the other computer to process the data, the computer receives from the other computer a log information item generated by the other computer in a process relating to the data, and when another computer transmits data to the computer and allows the computer to process the data, the computer receives a log information item from the other computer generated by the other computer in a process relating to the data, and
other processing log storing step which stores within said memory the log information item received by said log receiving step.

10. The log management method according to claim 9, further comprising,
a log transmitting step in which when said computer transmits data to another computer and allows the other computer to process the data, said computer transmits to the other computer, a log information item generated by the computer in a process relating to the data, and after the other computer has transmitted data to the computer and allowed the computer to process the data, the computer transmits to the other computer a log information item generated by the computer in a process relating to the data.

11. A computer system provided with a plurality of computers, and when a series of processes are subjected to a distributed processing in the plurality of computers, the computer system managing log information items with respect to each of the processes, the log information items being generated in course of executing the series of the processes, wherein,
a first computer in said plurality of computers comprises a processor and a memory, and said processor in said first computer executes,
own processing log storing step in which a log information item generated in course of processing in said first computer is stored in said memory within said first computer,
processing data transmission step which transmits unprocessed data to a second computer in said plurality of computers,
processing data receiving step which receives unprocessed data from said second computer,
log receiving step which receives from said second computer a log information item generated in a process by said second computer, relating to the unprocessed data that has been transmitted to said second computer by said processing data transmission step, and receives from said second computer the log information item generated in a process by said second computer, relating to the unprocessed data in course of transmitting the unprocessed data from said second computer, and
other processing log storing step which stores within said memory said log information item received by said log receiving step, and
said second computer comprises a processor, and said processor in said second computer executes,
processing data receiving step which receives said unprocessed data transmitted from said first computer,
processing data transmission step which transmits said unprocessed data to said first computer, and
log transmission step which transmits to said first computer said log information item generated in a process relating to said unprocessed data from said first computer received by said processing data receiving step in said second computer, and transmits to said first computer said log information item generated in the process relating to said unprocessed data in course of transmitting said unprocessed data by said processing data transmission step in said second computer.

12. The computer system according to claim 11, wherein,
said second computer comprises a memory, and
said processor of said second computer executes,
own processing log storing step which stores a log information item generated in a course of processing in said second computer in said memory within the second computer,
log receiving step which receives from said first computer a log information item generated in a process by said first computer, relating to the unprocessed data that has been transmitted to said first computer by said processing data transmission step in said second computer, and receives from said first computer the log information item generated in a process by said first computer, relating to the unprocessed data in course of transmitting the unprocessed data from said first computer, and
other processing log storing step which stores within said memory said log information item received by said log receiving step, and
said processor of said first computer executes,
log transmission step which transmits to said second computer said log information item generated in a process relating to said unprocessed data from said second computer received by said processing data receiving step in said first computer, and transmits to said second computer said log information item generated in the process relating to said unprocessed data in course of transmitting said unprocessed data by said processing data transmission step in said first computer.
